(19) United States
(12) Patent Application Publication
(10) Pub. No.: US 2008/0076472 A1
(43) Pub. Date: Mar. 27, 2008

(54) Intelligent Predictive Text Entry

(75) Inventor: Edward Craig Hyatt, Durham, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/534,362

(22) Filed: Sep. 22, 2006

(51) Int. Cl. H04B 1/38

(52) U.S. Cl. 455/557

(57) ABSTRACT

A method and apparatus for customizing lists of words or phrases predicted as part of a text prediction process for a mobile device is described herein. Accordingly, a memory in the mobile device stores a dictionary comprising a plurality of words, phrases, and other lexical units. The dictionary further stores one or more lexical tags corresponding to the stored lexical units. An application executed by the mobile device determines a search tag associated with a keypress combination input by a user using a keypad. A predictive text algorithm compares the search tag with the stored lexical tags. Based on the tag comparison and the user input, the predictive text algorithm generates a prediction list comprising one or more of the stored lexical units.

### BACKGROUND

The present invention relates generally to text entry in mobile devices, and more particularly to text prediction for mobile devices.

Common data entry operations implemented on a mobile communication device include composing a text message, entering contact information, composing an email, etc. For data entry, most mobile communication devices provide an abbreviated keyboard, such as an alphanumeric keypad. Each key on the abbreviated keyboard is responsible for multiple alphanumeric characters, and a multi-tap process is conventionally used for text entry. Multi-tap requires the user to activate or press a key one or more times to get the desired alphanumeric character. For example, conventional multi-tap requires the user to press the “7” key three times to get the letter “s.” The multiple key presses often make multi-tap data entry tedious and time consuming.

To facilitate data entry, many mobile communication devices include predictive text technology. Predictive text technology reduces the number of keypresses required to enter data by predicting multiple words or phrases based on the keypress combination input by the user. For example, entering “lips” using conventional multi-tap without predictive text technology requires 11 keypresses (5-5-5-4-4-4-7-7-7-7-7). With predictive text technology, the user may enter “lips” with just 4 keypresses (5-4-7-7).

One exemplary predictive text process uses a dictionary of commonly used words to find paragrams that match a particular keypress combination. Paragrams are different words produced by the same keypress combination. For example, the keypress combination 2-6-9 may produce the following paragrams: any, boy, box, bow, cow, amy, cox, coy, anx, and coz. To enter the desired word, the user scrolls through the list and selects the correct word.

Currently, a list of paragrams associated with a particular keypress combination is sorted based on how often the words are used. When there are a lot of paragrams in the prediction list, the number of keypresses required to select an infrequently used word may exceed the number of keypresses required to enter the word using conventional multi-tap. For example, entering “amy” using conventional multi-tap requires 5 keypresses (2-6-9-9-9); entering “amy” using a predictive text process that generates the prediction list of paragrams as ordered above requires 8 keypresses (2-6-9 plus 5 scroll keypresses). As such, there remains a need for improvements to predictive text technology.

### SUMMARY

The present invention provides a method and apparatus that customizes predictive text output for mobile devices. A plurality of words, phrases, or other lexical units and corresponding lexical tags are stored in a dictionary. A predictive text algorithm uses the dictionary to generate a prediction list based on the user's input. The prediction list contains likely words or phrases in the dictionary best matching the user's input. The lexical tags associate the lexical units with particular groups or categories of words or phrases. When a user enters text into an application, the application may provide a search tag to the predictive text algorithm indicating that the word or phrase being entered belongs to a particular group or category. When a search tag is provided, the predictive text algorithm compares the search tag with the lexical tags stored in the dictionary. The predictive text algorithm may use the comparison results to filter, sort, or otherwise process the prediction list. For example, the prediction list may be limited to only words and/or phrases that have a matching lexical tag. Alternatively, the predictive text algorithm may use the tag comparison results to sort the prediction list such that the words and/or phrases having a matching lexical tag appear at the top of the prediction list.

### BRIEF DESCRIPTION OF THE DRAWINGS

FIG. 1 shows an exemplary mobile device.

FIG. 2 shows an exemplary process diagram according to the present invention.

FIG. 3 shows an exemplary display output for the mobile device of FIG. 1.

FIG. 4 shows another exemplary display output for the mobile device of FIG. 1.

FIG. 5 shows an exemplary display output for a conventional mobile device.

FIGS. 6A and 6B show another exemplary display output for the mobile device of FIG. 1.

FIG. 7 shows a block diagram for an exemplary mobile device according to the present invention.

### DETAILED DESCRIPTION

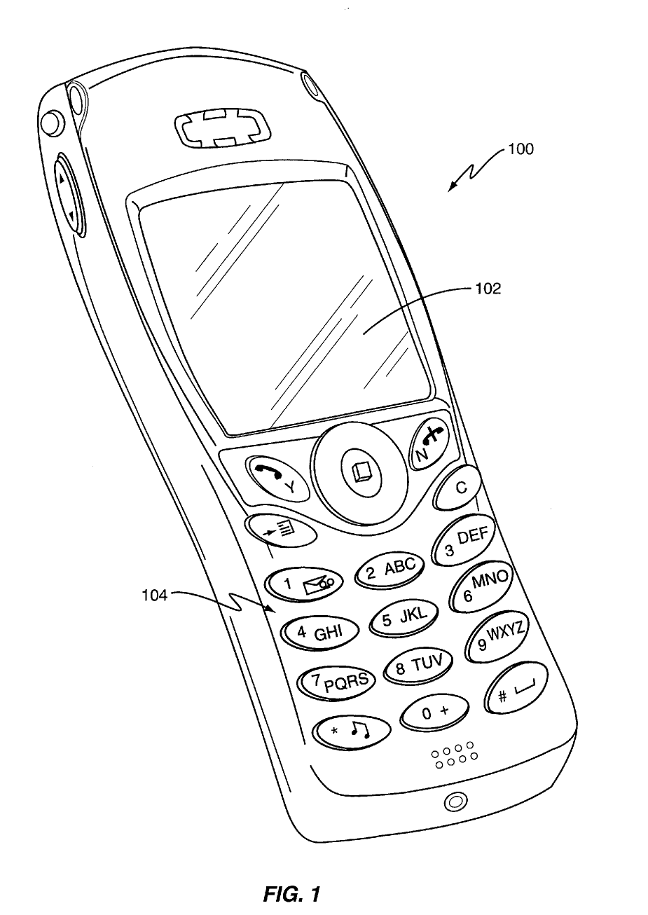

FIG. 1 shows one exemplary mobile device 100 having a display 102 and an abbreviated keyboard, such as an alphanumeric keypad 104. Display 102 displays information to the user. The user may use keypad 104 to input information and instructions, and otherwise control mobile device 100. While FIG. 1 illustrates a mechanical keypad 104, those skilled in the art will appreciate that other abbreviated keyboards may be used, including a virtual keypad accessed via display 102. Further, while FIG. 1 shows a cellular telephone, it will be appreciated that the present invention applies to any mobile device having an abbreviated keyboard, including cellular telephones, personal data assistants, palmtop computers, etc.

Keypad 104 includes a plurality of alphanumeric keys that each represent one or more alphanumeric characters, such as numbers 0-9, letters A-Z, and various punctuation marks. Because many keys represent multiple alphanumeric characters, one combination of multiple keypresses may generate multiple different words. For example, keypress combination 5-2-6-3-7 corresponds to the following paragrams: James, lanes, lands, or the zip code for Mediapolis, Iowa. Similarly, keypress combination 7-3-2 corresponds to the following paragrams: SEC (the acronym for South Eastern Conference), sec (an abbreviation for second), PDA (the acronym for Personal Data Assistant), sea, pea, or the area code for New Brunswick, N.J. Predictive text technology takes advantage of this phenomenon by generating a list of words that correspond to a particular keypress combination. However, because some keypress combinations produce a long list of words, text prediction technology is sometimes more cumbersome than conventional multi-tap data entry.

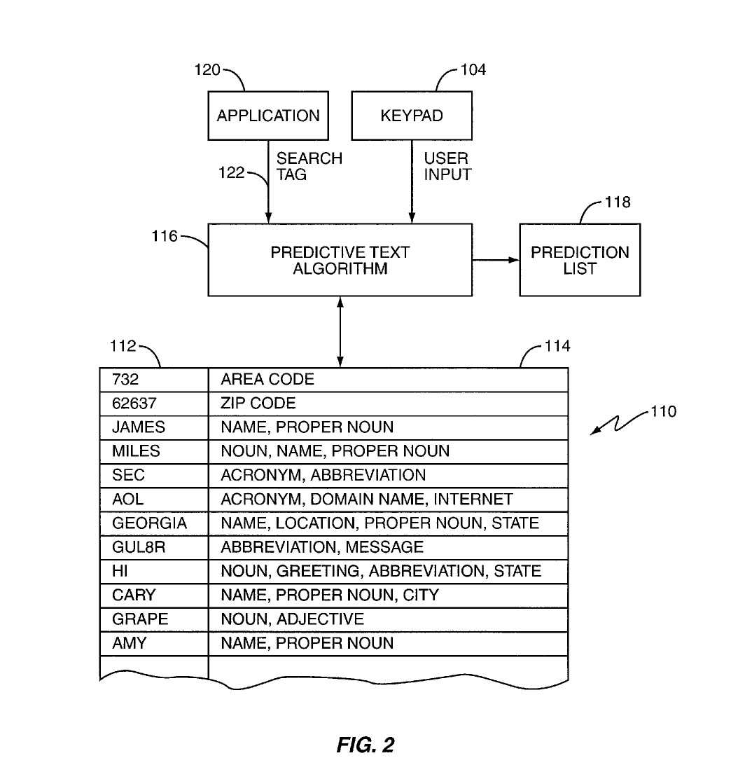

To address this problem, the present invention customizes predictive text output for mobile devices based on the particular category or group associated with the keypress combination entered by the user. FIG. 2 shows an exemplary predictive text process according to the present invention. A predictive text dictionary 110 stores a plurality of words, phrases, or other lexical units 112 and the corresponding lexical tags 114. Each lexical unit 112 is a word, phrase, or alphanumeric sequence that is intended to convey meaning. Exemplary lexical units 112 include but are not limited to numerical sequences, acronyms, abbreviations, slang words or phrases, conventional words or phrases, domain names, internet addresses, email addresses, geographical locations, emoticons, symbols, zip codes, area codes, and other alphanumeric sequences. Each lexical tag 114 provides a means of categorizing the lexical units 112 according to word type, function, group, or category. Exemplary lexical tags 114 include but are not limited to proper noun, name, zip code, area code, domain name, abbreviation, acronym, location, contact list, message, greeting, etc. In general, the lexical tags 114 are unrelated to user preferences or how often a user uses a particular lexical unit 112.

A predictive text algorithm 116 uses dictionary 110 to generate a prediction list 118 of likely lexical units 112 that best match both the user input and a search tag 122 associated with the user input. When the user enters text into an application 120, the application 120 provides the user's keypress combination to predictive text algorithm 116. The application 120 may also provide a search tag 122 associated with the keypress combination to predictive text algorithm 116. Application 120 may comprise an email application, text messaging application, contacts application, web browser application, etc. The provided search tag(s) 122 indicate the particular category, function, type, and/or group associated with the word or phrase being entered. Predictive text algorithm 116 compares the search tag(s) 122 with the lexical tags 114 stored in dictionary 110 and uses the results of the comparison to filter, sort, or otherwise process the prediction list 118. In some embodiments, the prediction list 118 may be further sorted based on a frequency of use associated with the words and/or phrases in the generated list 118.

The application 120 may use a number of techniques to determine the search tag(s) 122 based on the user input. In one embodiment, application 120 may comprise a data entry application, such as a contacts application, that enables a user to enter various types of data into multiple different data fields, as shown in FIG. 3. Each field may be associated with one or more search tags 122. When the user enters data into a data field, application 120 provides the corresponding search tag(s) 122 to the predictive text algorithm 116. For example, when the user enters data into the “Name” data field 124, application 120 generates a “name” search tag 122. Similarly, when the user enters data into a “phone” or “mobile” data field 126, application 120 generates a “phone number” search tag 122. Other exemplary data fields include but are not limited to email address, street address, city, state, zip code, domain name, and Internet address data fields.

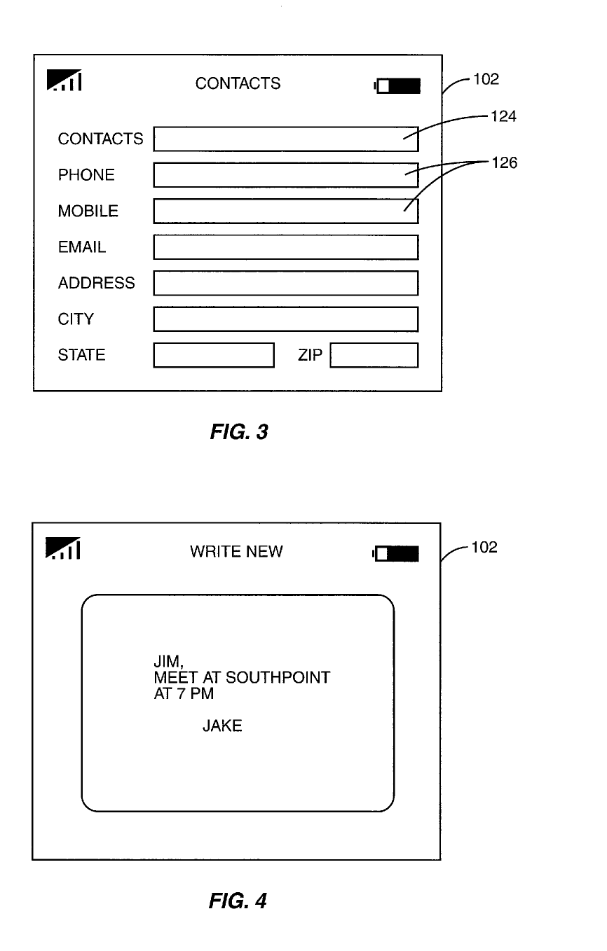

In another embodiment, application 120 may comprises a text editing application, such as a text messaging or email application, that enables the user to enter free form text, as shown in FIG. 4. Application 120 may then evaluate the grammar or other rules of syntax associated with the entered text to generate the search tag(s) 122. For example, because most messages typically begin with a greeting or a name, application 120 may generate a “name” and/or “greeting” search tag 122 for text entered at the beginning of a message. As another example, application 120 may generate an “acronym,” “abbreviation,” “name,” and/or “proper noun” search tag 122 when a user begins a word with a capital letter in the middle of a sentence. In the example in FIG. 4, such search tags 122 may be generated when the user enters “S” at the beginning of “Southpoint” and/or when the user enters “P” at the beginning of “PM.” Application 120 provides the generated search tag(s) 122 to predictive text algorithm 116.

Predictive text algorithm 116 compares the search tag(s) 122 provided by application 120 with the stored lexical tags 114 and generates the prediction list 118 based on both the tag comparison and the user input. Predictive text algorithm 116 may generate the prediction list 118 according to a variety of different methods. In one embodiment, predictive text algorithm 116 selects one or more of the stored lexical units 112 based on the user input. Based on the tag comparison, predictive text algorithm 116 filters the selected lexical units 112 to generate prediction list 118. In another embodiment, predictive text algorithm 116 selects one or more of the stored lexical units 112 based on the tag comparison and filters the selected lexical units 112 based on the user input to generate the prediction list 118. In both of these filtering embodiments, the generated prediction list 118 includes only those lexical units 112 that match both the user input and the search tag(s) 122.

In still another embodiment, predictive text algorithm 116 selects one or more of the stored lexical units 112 based on the user input. Based on the tag comparison, predictive text algorithm 116 sorts the selected lexical units 112 to generate the prediction list 118. For example, the predictive text algorithm 116 may place the lexical units 112 with matching lexical tags 114 at the top of the prediction list 118. As such, this sorting embodiment generates a prediction list 118 that not only prioritizes the most likely lexical units 112 based on the tag comparison, but also includes the other lexical units 112 that correspond to the user input.

To illustrate the invention, consider the following example. Assume the user enters the code 2-6-9 at the beginning of a text or email message. Conventional text prediction processes typically generate the following list 128: Any, Boy, Box, Bow, Cow, Amy, Cox, Coy, Anx, and Coz. At least a portion of the list 128 is output to display 102, as shown in FIG. 5. The user may select the desired word by scrolling through the list 128.

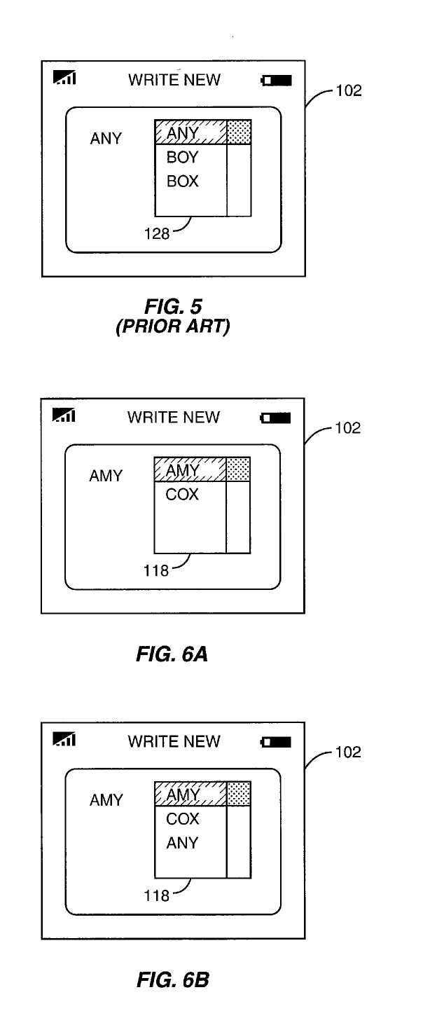

When the user enters the code 2-6-9 at the beginning of a message being input into a mobile device 100 of the present invention, application 120 may associate a “name” search tag 122 with the input keypress combination. According to the filtering embodiment, the prediction list 118 generated by predictive text algorithm 116 includes only those lexical units 112 that have a “name” lexical tag 114 and that correspond to the 2-6-9 keypress combination, namely “Amy” and “Cox.” At least a portion of the list 118 is output to display 102, as shown in FIG. 6A. According to the sorting embodiment, predictive text algorithm 116 places the lexical units 112 having a matching lexical tag 114 at the top of the generated prediction list 118 to facilitate access to the most likely word or phrase, as shown in FIG. 6B. In either case, the number of keypresses required to enter “Amy” is reduced from 8 keypresses to 3 or 4 keypresses. As such, the prediction list 118 generated according to the present invention provides the user with easier access to the word or phrase associated with the user input and most applicable to the current device operations.

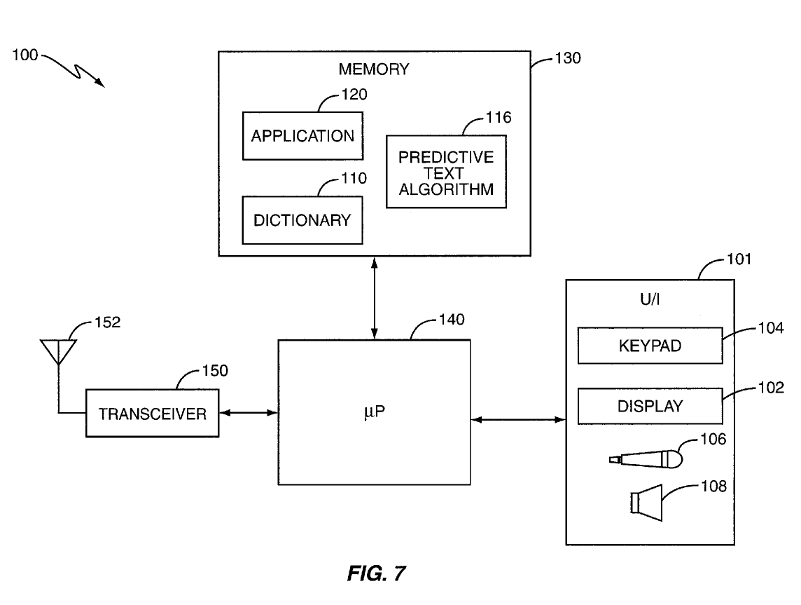

FIG. 7 shows a block diagram of one exemplary mobile device 100 that may be used to implement the above-described process 200. Mobile device 100 includes a user interface 101, memory 130, and processor 140. User interface 101 enables the user to interact with the mobile device 100. The user interface 101 includes display 102, keypad 104, a microphone 106, and a speaker 108. Memory 130 stores data and programs needed for operation, including the above-described dictionary 110, predictive text algorithm 116, and application(s) 120. Processor 140 performs various processing tasks, including control of the overall operation of mobile device 100, according to programs stored in memory 130. According to one embodiment, processor 140 executes predictive text algorithm 116 and one or more applications 120 to implement the text prediction process described above. When mobile device 100 is a mobile communication device, mobile device 100 may also include a transceiver 150 and antenna 152. Transceiver 150 may operate according to any known standard. Exemplary communication standards include but are not limited to, Code Division Multiple Access (CDMA), Global System for Mobile Communications (GSM), Universal Mobile Telecommunications System (UMTS), Orthogonal Frequency Division Multiplexing (OFDM), etc.

It will be appreciated that the above-described dictionary 110 does not require all stored lexical units 112 to have a lexical tag 114, and that a lexical unit 112 may be associated with one or more lexical tags 114. Further, it will be appreciated that dictionary 110 may comprise a fixed dictionary or a variable dictionary. The manufacturer of the mobile device 100 predefines the entries in a fixed dictionary. The manufacturer also initially sets the entries in a variable dictionary 110. Over time, the mobile device 100 expands the variable dictionary 110 to include words and phrases commonly used by the user.

While the above generally describes the invention in terms of a single search tag 122, the present invention is not so limited. It will be appreciated that multiple search tags 122 may be determined for a particular keypress combination. For example, application 120 may determine two search tags 122, such as a “name” search tag 122 and a “greeting” search tag 122, for a user input entered at the beginning of a message. Predictive text algorithm 116 uses both search tags 122 when generating the prediction list 118.

Also, while the above describes the predictive text algorithm 116 and application(s) 120 as programs stored in memory 130 and executed by processor 140, those skilled in the art will appreciate that some or all aspects of algorithm 116 and/or application(s) 120 may be embodied in hardware and/or in software (including firmware, resident software, micro-code, etc.), including an application specific integrated circuit (ASIC).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of implementing a predictive text process comprising:
storing a plurality of lexical units and corresponding lexical tags in a dictionary;
receiving user input from an abbreviated keyboard;
determining a search tag associated with the user input;
comparing the search tag with the stored lexical tags; and
generating a prediction list comprising one or more of the stored lexical units based on the user input and the tag comparison.

2. The method of claim 1 wherein generating the prediction list comprises:
selecting one or more of the stored lexical units based on the user input; and
filtering the selected lexical units based on the tag comparison to generate the prediction list.

3. The method of claim 1 wherein generating the prediction list comprises:
selecting one or more of the plurality of stored lexical units based on the user input; and
sorting the selected lexical units based on the tag comparison to generate the prediction list.

4. The method of claim 3 wherein sorting the selected lexical units comprises placing the lexical units having a lexical tag that matches the search tag at the top of the prediction list.

5. The method of claim 1 wherein determining the search tag associated with the user input comprises determining the search tag based on an application data field associated with the user input.

6. The method of claim 1 wherein determining the search tag associated with the user input comprises determining the search tag based on a grammatical evaluation of the user input.

7. The method of claim 1 further comprising outputting at least a portion of the prediction list to a display.

8. The method of claim 1 further comprising outputting a user selected one of the lexical units in the prediction list to a display.

9. A mobile device comprising:
a memory configured to store a dictionary comprising a plurality of lexical units and corresponding lexical tags;
an abbreviated keyboard configured to receive user input, said user input having a corresponding search tag; and
a processor operatively connected to the memory and to the abbreviated keyboard, said processor configured to execute a predictive text algorithm to compare the search tag with the stored lexical tags and to generate a prediction list comprising one or more of the stored lexical units based on the user input and the tag comparison.

10. The mobile device of claim 9 wherein the processor generates the prediction list by selecting one or more of the stored lexical units based on the user input and by filtering the selected lexical units based on the tag comparison to generate the prediction list.

11. The mobile device of claim 9 wherein the processor generates the prediction list by selecting one or more of the stored lexical units based on the user input and by sorting the selected lexical units based on the tag comparison to generate the prediction list.

12. The mobile device of claim 11 wherein the processor is configured to sort the selected lexical units by placing the lexical units having a lexical tag that matches the search tag at the top of the prediction list.

13. The mobile device of claim 9 further comprising a display configured to display at least a portion of the prediction list.

14. The mobile device of claim 9 further comprising a display configured to display a user selected one of the lexical units in the prediction list.

15. The mobile device of claim 9 wherein the abbreviated keyboard comprises at least one of a mechanical keypad and a virtual keypad.

16. The mobile device of claim 9 wherein the mobile device comprises a cellular telephone.

17. The mobile device of claim 9 wherein the processor is configured to execute an application to determine the search tag associated with the user input.

18. The mobile device of claim 17 wherein the application determines the search tag based on at least one of a data field associated with the user input and a grammatical evaluation of the user input.

19. A method of displaying predicted alphanumeric expressions comprising:
receiving user input from an abbreviated keyboard;
determining a search tag associate with the user input;
selecting one or more lexical units from a plurality of stored lexical units based on the user input; and
sorting the selected lexical units based on the search tag.

20. The method of claim 19 wherein determining the search tag associated with the user input comprises determining the search tag based on at least one of a data field associated with the user input and a grammatical evaluation of the user input.
